(19) United States
(12) Patent Application Publication
(10) Pub. No.: US 2026/0196369 A1
(43) Pub. Date: Jul. 9, 2026

(54) DEVICE FOR INSPECTING A NUCLEAR REACTOR VESSEL

(71) Applicant: INTERCONTROLE, RUNGIS (FR)

(72) Inventors: Eric ARTILLAN, MIRABEAU (FR); Geoffrey GARZINO, VINON SUR VERDON (FR)

(21) Appl. No.: 19/133,209

(22) PCT Filed: Nov. 27, 2023
(86) PCT No.: PCT/EP2023/083191

§ 371 Date: May 27, 2025

(30) Foreign Application Priority Data
Nov. 28, 2022 (FR) FR2212418

(51) Int. Cl. G21C 17/01

(52) U.S. Cl. CPC G21C 17/01

(57) ABSTRACT

A device for inspecting a nuclear reactor vessel, the device includes a support unit and an inspection tool mounted on the support unit. The inspection tool has a carriage and an inspection head, the carriage being mounted on the support unit such as to be mobile in translation along a horizontal axis of translation, and the inspection head being configured for insertion into the connecting pipe and carrying one or more probes for performing measurements at the connecting pipe. The translation of the carriage permits insertion of the inspection head into the connecting pipe. The inspection head is mounted on the carriage via a positioning tool having at least two degrees of freedom, including a translation along a vertical positioning direction and a rotation about a vertical positioning axis.

### CROSS-REFERENCE TO RELATED APPLICATIONS

This application is the U.S. National Phase of PCT Appl. No. PCT/EP2023/083191 filed Nov. 27, 2023, which claims priority to FR 22 12418, filed Nov. 28, 2022, the entire disclosures of which are incorporated by reference herein.

### TECHNICAL FIELD

The present disclosure relates to the field of inspecting nuclear reactor vessels, particularly a device for inspecting a nuclear reactor vessel.

### BACKGROUND

A light water nuclear reactor comprises a nuclear reactor vessel receiving a reactor core composed of multiple nuclear fuel assemblies containing nuclear fuel and arranged side by side in the nuclear reactor vessel.

The nuclear reactor vessel is closed by a lid and equipped with connecting pipes that open into the nuclear reactor vessel, through which the nuclear reactor vessel is connected to loops of a fluid circuit, called the “primary circuit,” designed for the circulation of water called “primary water.”

Each loop of the primary circuit is equipped with a pump, called a “primary pump,” to ensure the circulation of primary water in the loop, and a steam generator to generate steam using the primary water circulating in the loop. The primary circuit has at least one pressurizer to maintain the primary water at a given pressure in the primary circuit and in the nuclear reactor vessel.

In operation, the primary water circulates in the loops passing through the nuclear reactor vessel. The primary water is heated in the nuclear reactor vessel in contact with the nuclear fuel assemblies and directed to the steam generators in the loops of the primary circuit.

Thus, the primary circuit is a closed circuit that ensures the transmission of heat released in the nuclear reactor core (where the fuel is located and the chain reaction occurs) to the steam generators that transform this heat into steam.

It is necessary to carry out inspections of the nuclear reactor vessel, particularly inspections of the connecting pipes equipping the nuclear reactor vessel. Such inspections are carried out, e.g. during maintenance operations implemented during a shutdown phase of the nuclear reactor.

It is desirable to be able to perform the inspection of the nuclear reactor vessel in a simple and efficient manner, to limit the time required for maintenance operations.

### SUMMARY

One of the aims of the present disclosure is to propose a device for inspecting a nuclear reactor vessel that allows for simple and efficient inspection.

To this end, the present disclosure proposes a device for inspecting a nuclear reactor vessel equipped with a connecting pipe opening into the nuclear reactor vessel, the inspection device comprising a support unit configured to be mounted on the nuclear reactor vessel, and an inspection tool mounted on the support unit, the inspection tool comprising a carriage and an inspection head carried by the carriage, the carriage being mounted on the support unit to be mobile in translation along a horizontal axis of translation, the inspection head being configured to be inserted into the connecting pipe and carrying one or more probes for performing measurements on the connecting pipe, the translation of the carriage allowing the inspection head to engage in the connecting pipe, wherein the inspection head is mounted on the carriage via a positioning tool comprising at least two degrees of freedom comprising a translation along a vertical positioning direction and a rotation around a vertical positioning axis.

The positioning tool having a degree of freedom in translation along a vertical direction and a degree of freedom in rotation around a vertical axis allows the inspection head inserted into a connecting pipe to be positioned easily and appropriately to perform precise and relevant measurements, particularly when the connecting pipe has a bend.

According to particular embodiments, the inspection device comprises one or more of the following optional features, taken individually or in any technically possible combinations:
the positioning tool comprises a sliding connection allowing translation along the vertical positioning direction;
the positioning tool comprises a pivot connection allowing rotation around the vertical positioning axis;
the positioning tool comprises a degree of freedom in rotation around a horizontal positioning axis;
the positioning tool comprises a pivot connection allowing rotation around the horizontal positioning axis;
the positioning tool comprises a sliding connection allowing translation along the vertical positioning direction, a pivot connection allowing rotation around the vertical positioning axis, and a pivot connection allowing rotation around the horizontal positioning axis;
the sliding connection, the pivot connection of the vertical positioning axis, and the pivot connection of the horizontal positioning axis are arranged kinematically in series between a base of a mounting mechanism configured to be fixed on the carriage and the inspection head, preferably in this order;
the positioning tool is equipped with actuators for controlling the position of the inspection head relative to a base of the positioning tool fixed on the carriage;
the support unit comprises a mounting assembly configured to be installed on the nuclear reactor vessel and carrying a tooling support, the carriage being mounted mobile in translation along the axis of translation on the tooling support;
the positioning tool is mounted mobile in rotation around a vertical rotation axis relative to the mounting assembly via a rotary mechanism;
the mounting assembly comprises a support assembly configured to rest on an upper edge of the nuclear reactor vessel and a mounting column extending vertically downward from the support assembly, the tooling support being mounted at a lower end of the mounting column;
the support assembly comprises a central part and legs extending radially from the central part, each leg having a distal end opposite the central part configured to rest on the upper edge of the nuclear reactor vessel, the mounting column extending downward from the central part;
each leg is a metal beam extending substantially horizontally when the support unit is installed on the nuclear reactor vessel;
each leg is mounted removably on the central part and/or the mounting column is fixed removably on the central part;
the support assembly comprises a respective foot disposed at the distal end of each leg and through which the leg rests on the upper edge of the nuclear reactor vessel, the feet being configured for self-centering the support unit relative to the nuclear reactor vessel under the effect of the weight of the support unit;
each foot is articulated on the associated leg around an articulation axis and has a vertical support portion arranged to rest vertically on the upper edge of the nuclear reactor vessel and a horizontal support portion arranged to rest horizontally on a side wall of the nuclear reactor vessel, so that when the support unit is placed on the nuclear reactor vessel, each foot rests vertically on the upper edge of the nuclear reactor vessel through its vertical support portion, which tends to rotate the foot around its articulation axis and move the horizontal support portion of the foot in contact with the side wall under the effect of the weight of the support unit;
each probe is chosen from an eddy current probe or an ultrasonic probe;
the inspection head carries several probes arranged in a star configuration, the probes being distributed around a central axis of the inspection head, each probe being oriented radially outward.

### BRIEF DESCRIPTION OF THE DRAWINGS

The present disclosure and its advantages will be better understood by reading the following description, given solely by way of non-limiting example and made with reference to the appended drawings, in which:

FIG. 1 is a sectional view of a nuclear reactor vessel and an inspection device fixed on the vessel for inspecting a connecting pipe of the nuclear reactor vessel;

FIG. 2 is a perspective view of the inspection device;

FIG. 3 is a perspective view of a positioning tool and an inspection head carried by the positioning tool;

FIG. 4 is a perspective view of the inspection device disassembled and packaged for transport.

### DETAILED DESCRIPTION

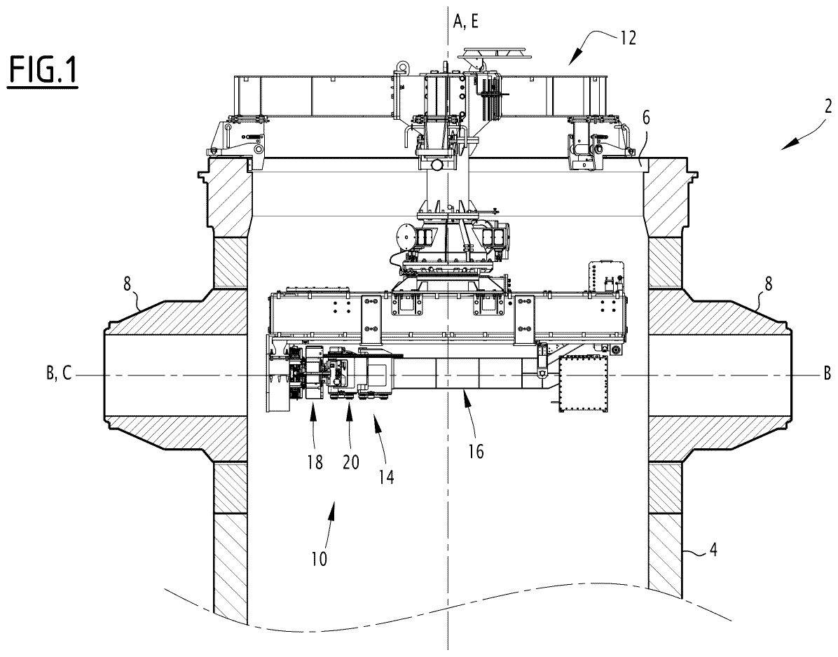

As illustrated in FIG. 1, a nuclear reactor vessel 2 extends along a central vertical axis hereinafter referred to as the vessel axis A.

The nuclear reactor vessel 2 comprises a cylindrical side wall 4 with a circular cross-section centered on the vessel axis A, whose lower end is closed by a bottom (not visible), e.g. hemispherical.

The nuclear reactor vessel 2 has, at the upper end of its side wall 4, an upper edge delimiting an upper opening 6 intended to be closed with a lid (not visible).

In a known manner, the side wall 4 has at its upper end an annular fixing region, generally called a flange, configured for fixing the lid on the side wall 4.

The fixing is generally carried out using bolts distributed around the circumference of the flange, which comprises fixing holes designed to receive the bolts.

The nuclear reactor vessel 2 is equipped with connecting pipes 8 for connecting the nuclear reactor vessel 2 to the primary circuit of the nuclear power plant. Two diametrically opposed connecting pipes 8 are visible in FIG. 1. In practice, the nuclear reactor vessel 2 is equipped, e.g. with two, four, six, or eight connecting pipes 8.

Each connecting pipe 8 opens into the interior of the nuclear reactor vessel 2, particularly on the side wall 4, along a substantially horizontal pipe axis B.

The pipe axis B of each connecting pipe 8 is preferably radial relative to the vessel axis A of the nuclear reactor vessel 2.

Each connecting pipe 8 may have a bend located along the connecting pipe 8 at a distance from the junction of the connecting pipe 8 with the side wall 4. An inspection device 10 is mounted on the nuclear reactor vessel 2.

The inspection device 10 is placed on the upper edge of the side wall 4, particularly on the flange of the side wall 4.

In the following description, orientation terms such as “horizontal” and “vertical,” “top” and “bottom” are extended by reference to the inspection device 10 mounted on the nuclear reactor vessel 2.

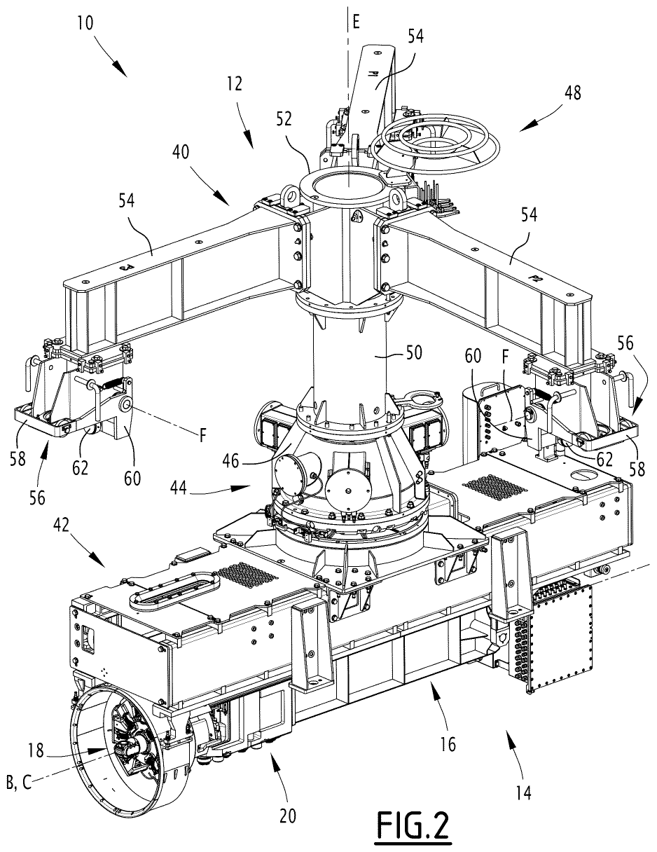

As illustrated in FIGS. 1 and 2, the inspection device 10 comprises a support unit 12 configured to be installed on the nuclear reactor vessel 2 and an inspection tool 14 mounted on the support unit 12.

The inspection tool 14 comprises a carriage 16 carried by the support unit 12, with being mobile in translation along a horizontal axis of translation C relative to the support unit 12, and an inspection head 18 configured to be inserted into a connecting pipe 8 to perform an inspection of the connecting pipe 8, particularly to perform measurements inside the connecting pipe 8, the inspection head 18 being mounted on the carriage 16 via a positioning tool 20.

As illustrated in FIG. 1, the support unit 12 is configured such that the carriage 16 is positioned with its horizontal axis of translation C parallel to, and preferably coinciding with the pipe axis B of the connecting pipe 8 being inspected 8.

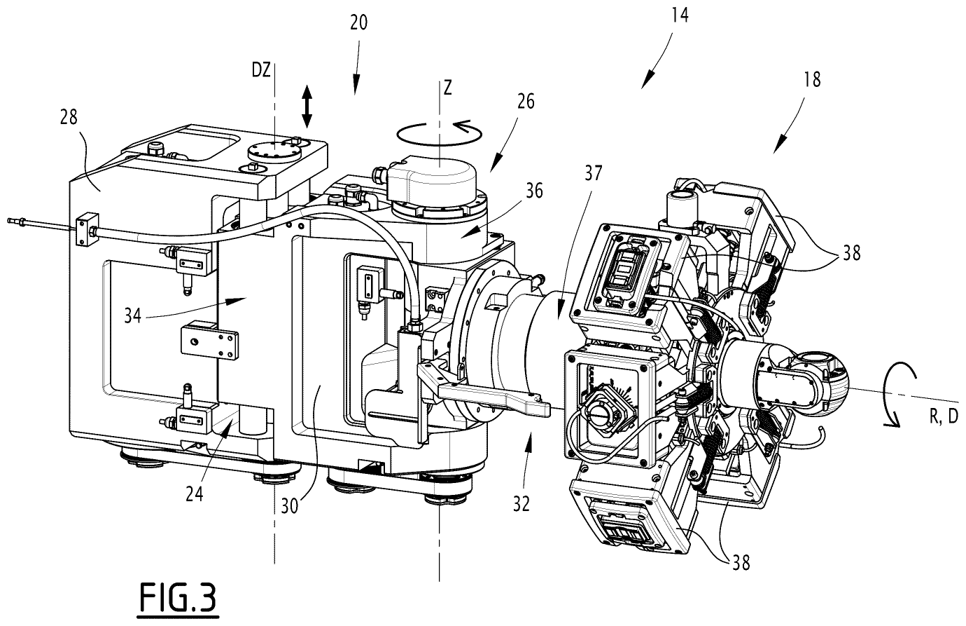

As illustrated in FIG. 3, the positioning tool 20 comprises at least two degrees of freedom, comprising a translation along a vertical positioning direction DZ and a rotation around a vertical positioning axis Z.

Thus, the positioning tool 20 allows the inspection head 18 to move relative to the carriage 16 in translation along the vertical positioning direction DZ and in rotation around the vertical positioning axis Z.

The positioning tool 20 comprises, e.g. a sliding connection 24 allowing translation along the vertical positioning direction DZ. The sliding connection 24 has as its sole degree of freedom the translation along the vertical positioning direction DZ.

The positioning tool 20 comprises, e.g. a pivot connection 26 allowing rotation around the vertical positioning axis Z. The pivot connection 26 has as its sole degree of freedom the rotation around the vertical positioning axis Z.

Preferably, the sliding connection 24 and the pivot connection 26 are arranged kinematically in series between the carriage 16 and the inspection head 18, particularly in this order.

The positioning tool 20 comprises, e.g. a base 28 configured to be rigidly fixed on the carriage 16 and an intermediate part 30 mounted on the base 28 via one of the sliding connection 24 and the pivot connection 26, the inspection head 18 being mounted on the intermediate part 30 via the other of the sliding connection 24 and the pivot connection 26.

Preferably, the intermediate part 30 is mounted on the base 28 via the sliding connection 24, and the inspection head 18 is mounted on the intermediate part 30 via the pivot connection 26.

Advantageously, the positioning tool 20 has a degree of freedom in rotation around a horizontal positioning axis R. The inspection head 18 is carried by the carriage 16, being mobile in rotation around the horizontal positioning axis R.

The positioning tool 20 comprises, e.g. a pivot connection 32 allowing rotation around the horizontal positioning axis R. The pivot connection 32 has as its sole degree of freedom the rotation around the horizontal positioning axis R.

In an example of embodiment with the intermediate part 30, the inspection head 18 is mounted on the intermediate part 30 via the pivot connection 32.

Advantageously, the positioning tool 20 comprises exactly three degrees of freedom, namely the translation along the vertical positioning direction DZ, the rotation around the vertical positioning axis Z, and the rotation around the horizontal positioning axis R.

Advantageously, the positioning tool 20 is equipped with actuators configured to move the inspection head 18 relative to the carriage 16 according to each degree of freedom of the positioning tool 20.

Each actuator of the positioning tool 20 is, e.g. an electric actuator, particularly an electric motor, a pneumatic actuator, or a hydraulic actuator.

The positioning tool 20 comprises, e.g. a translation actuator 34 to ensure translation along the vertical positioning direction DZ, a vertical rotation actuator 36 to ensure rotation around the vertical positioning axis Z, and/or a horizontal rotation actuator 37 to ensure rotation around the horizontal positioning axis R.

The inspection head 18 carries one or more probes 38, each probe 38 being configured to perform measurements on the connecting pipe 8 into which the inspection head 18 is inserted.

Each probe 38 is, e.g. chosen from an eddy current probe and an ultrasonic probe. Such probes allow non-destructive testing to be performed on metal parts and/or welds of the connecting pipe 8.

Each probe 38 is, e.g. directed radially relative to a central axis D of the inspection head 18 coinciding with the pipe axis B when the inspection head 18 is inserted into the connecting pipe 8.

As in the illustrated example, when the inspection head 18 is rotative relative to the carriage 16 around a horizontal positioning axis R, this horizontal positioning axis R preferably coincides with the central axis D of the inspection head 18.

The inspection head 18 comprises, e.g. several probes 38 arranged in a star around the central axis D of the inspection head 18, each probe 38 being directed radially outward relative to the central axis D of the inspection head 18.

As visible in FIG. 2, the support unit 12 comprises a mounting assembly 40 configured to be placed on the nuclear reactor vessel 2 and carrying a tooling support 42, the carriage 16 of the inspection tool 14 being mounted in translation on the tooling support 42 along the axis of translation C.

Preferably, the tooling support 42 is mounted mobile in rotation around a vertical orientation axis E relative to the mounting assembly 40 via a rotary mechanism 44. The rotary mechanism 44 comprises, e.g. a rotating ring.

The rotary mechanism 44 is preferably equipped with an actuator 46 to ensure the rotation of the tooling support 42 around the orientation axis E relative to the mounting assembly 40. The actuator 46 is, e.g. an electric actuator, such as an electric motor, a pneumatic actuator, or a hydraulic actuator.

The mounting assembly 40 is configured to be placed on the nuclear reactor vessel 2, particularly on the upper edge of the nuclear reactor vessel 2, so that the orientation axis E of the tooling support 42 coincides with the central axis A of the nuclear reactor vessel 2.

The mounting assembly 40 comprises, e.g. a support assembly 48 configured to rest on the upper edge of the nuclear reactor vessel 2, and a mounting column 50 extending vertically downward from the support assembly 48, the tooling support 42 being mounted at a lower end of the mounting column 50, preferably via the rotary mechanism 44 disposed at the lower end of the mounting column 50.

As illustrated in FIG. 1, when the mounting assembly 40 is installed on the nuclear reactor vessel 2, the mounting column 50 extends vertically downward inside the nuclear reactor vessel 2, and the tooling support 42 is located inside the nuclear reactor vessel 2.

The support assembly 48 comprises, e.g. a star configuration and has a central part 52 and several legs 54, particularly three legs 54, extending radially from the central part 52, each leg 54 having a proximal end connected to the central part 52 and a distal end opposite the central part 52 configured to rest on the upper edge of the nuclear reactor vessel 2.

The support unit 12 is preferably dismountable to facilitate its transport. The inspection device 10 can indeed be transported from one nuclear reactor to another to perform inspections of different nuclear reactors.

Preferably, each leg 54 of the support assembly 48 is mounted removably on the central part 52 of the support assembly 48. This allows the support assembly 48 to be disassembled.

Preferably, the mounting column 50 is mounted removably on the support assembly 48, particularly on the central part 52 of the support assembly 48. It is possible to have several mounting columns 50 of different lengths and to choose the appropriate mounting column 50 depending on the height at which the connecting pipes 8 of a nuclear reactor vessel 2 to be inspected are located.

Advantageously, each leg 54 is a metal beam extending substantially horizontally when the support assembly 48 is placed on the upper edge of the nuclear reactor vessel 2.

A support assembly 48 with such legs 54 has reduced vertical dimensions, which facilitates the deployment of the inspection device 10, given that the available space in a nuclear power plant is limited.

Advantageously, the support assembly 48 comprises, at the distal end of each leg 54, a foot 56 through which the leg 54 rests on the nuclear reactor vessel 2, particularly on the upper edge of the nuclear reactor vessel 2 during the installation of the support unit 12 on the nuclear reactor vessel 2.

The feet 56 are configured for self-centering the support unit 12 relative to the nuclear reactor vessel 2, the self-centering being operated under the effect of the weight of the support unit 12 during the placement of the support unit 12 on the upper edge of the nuclear reactor vessel 2.

In an embodiment, each foot 56 is articulated on the associated leg 54 around an articulation axis F, which is horizontal and preferably orthoradial relative to the central axis A of the nuclear reactor vessel 2, and has a vertical support portion 58 arranged to rest vertically on the upper edge of the nuclear reactor vessel 2 and a horizontal support portion 60 arranged to rest horizontally on the side wall 4 of the nuclear reactor vessel 2, preferably via a horizontal support pad 62.

The feet 56 are configured so that when the support unit 12 is placed on the nuclear reactor vessel 2, each foot 56 rests vertically on the nuclear reactor vessel 2 through its vertical support portion 58, which tends to rotate the foot 56 around its articulation axis F and move the horizontal support portion 60 of the foot 56 in contact with the side wall 4 under the effect of the weight of the support unit 12.

This substantially simultaneous support of the horizontal support portions 60 of the feet 56 on the side wall 4 of the nuclear reactor vessel 2 during the placement of the support unit 12 causes automatic centering of the support unit 12 under the effect of the weight of the support unit 12.

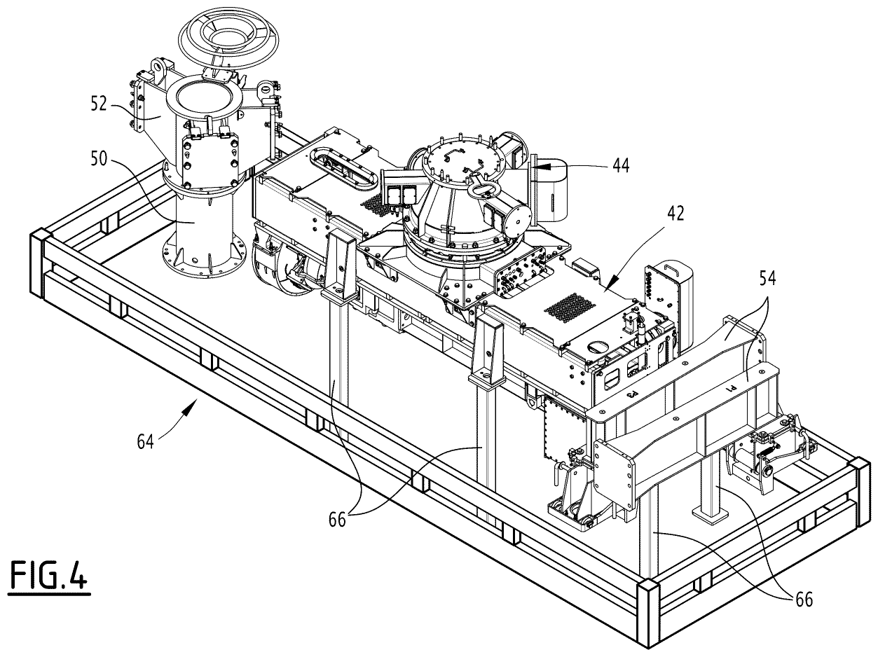

As illustrated in FIG. 4, the dismountable support unit 12 is easily transportable, e.g. on a transport cradle 64 equipped with supports 66 for fixing the different separable elements of the support unit 12.

In the illustrated example, the tooling support 42 equipped with the rotary mechanism 44 is placed on dedicated supports 66. The central part 52 and the mounting column 50 held assembled are fixed on the transport cradle 64. The legs 54 are disassembled from the central part 52 and fixed on dedicated supports 66. Only two of the legs 54 are visible in FIG. 4.

In operation, if necessary, the support unit 12 is assembled, e.g. by fixing the legs 54 on the central part 52, thus forming the support assembly 48, and by fixing the assembly formed by the tooling support 42 and the rotary mechanism 44 at the lower end of the mounting column 50.

The inspection tool 14 is mounted on the tooling support 42. More particularly, the carriage 16 is mounted on the tooling support 42, the inspection head 18 being carried by the carriage 16 via the positioning tool 20.

The mounting assembly 40 is placed resting on the upper edge of the nuclear reactor vessel 2. The tooling support 42 is then located inside the nuclear reactor vessel 2, the inspection tool 14 being positioned at the appropriate height for inserting the inspection head 18 into a connecting pipe 8 to be inspected.

The tooling support 42 is rotated around the orientation axis E to orient the inspection tool 14 towards a connecting pipe 8, particularly to align the horizontal axis of translation C with the pipe axis B of this connecting pipe 8.

The carriage 16 is moved in translation to introduce the inspection head 18 into the connecting pipe 8. Measurements are performed using the one or a plurality of probes 38, by moving the inspection head along the pipe axis B, and, if possible, by moving the inspection head 18 in rotation around the horizontal positioning axis R.

The degrees of freedom of the positioning tool 20 in vertical translation along the vertical positioning direction DZ and in rotation around the vertical positioning axis Z allow the position of the inspection head 18 inside the connecting pipe 8 to be refined.

This allows precise positioning of the probes 38, which may be sensitive to a variation in distance between each probe 38 and the internal surface of the connecting pipe 8.

In particular, the vertical translation along the vertical positioning direction DZ allows precise vertical positioning, even in the absence of vertical mobility of the tooling support 42, or more precise than with vertical movement of the tooling support 42, as only the inspection head 18 is moved vertically, which can be done more precisely.

Furthermore, the connecting pipe 8 may have a bend, particularly a bend turning in the horizontal plane.

The degree of freedom in rotation around the vertical positioning axis Z allows inspecting such a bend of the connecting pipe 8, by rotating the inspection head 18 to advance it into the bend while keeping it aligned with the local central axis of the connecting pipe 8.

By means of the inspection device 10, it is possible to perform a reliable and efficient inspection. The inspection precision is satisfactory, and the inspection time can be reduced, which ultimately limits the downtime of the nuclear reactor.

The inspection device 10 is also easy to deploy and transport, notably due to its support unit 12, which is of reduced dimensions, particularly because it is not necessary to provide a mounting column 50 allowing vertical translation of the tooling support 42, and the possible disassembly of its support unit 12.

The dismountable support unit 12 is advantageous independently of the positioning tool 20.

Thus, according to another aspect, the present disclosure relates to an inspection device 10 for a nuclear reactor vessel 2 equipped with a connecting pipe 8 opening into the nuclear reactor vessel 2, the inspection device 10 comprising a support unit 12 configured to be mounted on the nuclear reactor vessel 2 and an inspection tool 18 mounted on the support unit 12, the support unit 12 comprising a mounting assembly 40 configured to rest on the upper edge of the nuclear reactor vessel 2 and carrying a tooling support 42 carrying the inspection tool 18, the mounting assembly 40 comprising a central part 52 and several legs 54, particularly three legs 54, extending radially from the central part 52, each leg 54 having a proximal end connected to the central part 52 and a distal end opposite the central part 52 configured to rest on the upper edge of the nuclear reactor vessel 2, each leg 54 being mounted removably on the central part 52.

According to particular embodiments, the inspection device comprises one or more of the following optional features:
each leg 54 is a metal beam extending substantially horizontally when the mounting assembly 40 is installed on the nuclear reactor vessel 2;
the mounting assembly 40 comprises a mounting column 50 extending vertically downward from the central part 52;
the mounting column 50 is mounted removably on the central part 52;
the tooling support 42 is mounted mobile in rotation around a vertical orientation axis E relative to the central part 52; and
the tooling support 42 is mounted at the lower end of the mounting column 50.

1-18. (canceled)

19: An inspective device for inspecting a nuclear reactor vessel equipped with a connecting pipe opening into the nuclear reactor vessel, the inspection device comprising:
a support unit configured to be mounted on the nuclear reactor vessel; and
an inspection tool mounted on the support unit, the inspection tool comprising a carriage and an inspection head carried by the carriage, the carriage being mounted on the support unit to be mobile in translation along a horizontal axis of translation, the inspection head being configured to be inserted into the connecting pipe and carrying one or more probes for performing measurements on the connecting pipe, the translation of the carriage allowing the inspection head to engage in the connecting pipe, the inspection head being mounted on the carriage via a positioning tool comprising at least two degrees of freedom comprising a translation along a vertical positioning direction and a rotation around a vertical positioning axis.

20: The inspection device according to claim 19, wherein the positioning tool comprises a sliding connection allowing translation along the vertical positioning direction.

21: The inspection device according to claim 19, wherein the positioning tool comprises a pivot connection allowing rotation around the vertical positioning axis.

22: The inspection device according to claim 19, wherein the positioning tool comprises a degree of freedom of rotation around a horizontal positioning axis.

23: The inspection device according to claim 22, wherein the positioning tool comprises a pivot connection allowing rotation around the horizontal positioning axis.

24: The inspection device according to claim 22, wherein the positioning tool comprises a sliding connection allowing translation along the vertical positioning direction, a pivot connection allowing rotation around the vertical positioning axis, and a pivot connection allowing rotation around the horizontal positioning axis.

25: The inspection device according to claim 24, wherein the sliding connection, the pivot connection of the vertical positioning axis, and the pivot connection of the horizontal positioning axis are arranged kinematically in series between a base of a mounting mechanism configured to be fixed on the carriage and the inspection head.

26: The inspection device according to claim 24, wherein the sliding connection, the pivot connection of the vertical positioning axis, and the pivot connection of the horizontal positioning axis are arranged kinematically in series between a base of a mounting mechanism configured to be fixed on the carriage and the inspection head, in this order.

27: The inspection device according to claim 19, wherein the positioning tool is equipped with actuators for controlling the position of the inspection head relative to a base of the positioning tool fixed on the carriage.

28: The inspection device according to claim 19, wherein the support unit comprises a mounting assembly configured to be installed on the nuclear reactor vessel and carrying a tooling support, the carriage being mounted mobile in translation along an axis of translation on the tooling support.

29: The inspection device according to claim 28, wherein the tooling support is mounted mobile in rotation around a vertical rotation axis relative to the mounting assembly via a rotary mechanism.

30: The inspection device according to claim 28, wherein the mounting assembly comprises a support assembly configured to rest on an upper edge of the nuclear reactor vessel and a mounting column extending vertically downward from the support assembly, the tooling support being mounted at a lower end of the mounting column.

31: The inspection device according to claim 30, wherein the support assembly comprises a central part and legs extending radially from the central part, each leg having a distal end opposite the central part configured to rest on the upper edge of the nuclear reactor vessel, the mounting column extending downward from the central part.

32: The inspection device according to claim 31, wherein each leg is a metal beam extending substantially horizontally when the support unit is installed on the nuclear reactor vessel.

33: The inspection device according to claim 31, wherein each leg is mounted removably on the central part and/or the mounting column is fixed removably on the central part.

34: The inspection device according to claim 31, wherein the support assembly comprises a respective foot disposed at the distal end of each leg and through which the leg rests on the upper edge of the nuclear reactor vessel, the feet being configured for self-centering the support unit relative to the nuclear reactor vessel under an effect of the weight of the support unit.

35: The inspection device according to claim 34, wherein each foot is articulated on the associated leg around an articulation axis and has a vertical support portion arranged to rest vertically on the upper edge of the nuclear reactor vessel and a horizontal support portion arranged to rest horizontally on a side wall of the nuclear reactor vessel, so that when the support unit is placed on the nuclear reactor vessel, each foot rests vertically on the upper edge of the nuclear reactor vessel through its vertical support portion, which tends to rotate the foot around its articulation axis and move the horizontal support portion of the foot in contact with the side wall under the effect of the weight of the support unit.

36: The inspection device according to claim 19, wherein each probe is chosen from an eddy current probe or an ultrasonic probe.

37: The inspection device according to claim 19, wherein the inspection head carries several probes arranged in a star configuration, the probes being distributed around a central axis of the inspection head, each probe being oriented radially outward.
